(19) United States
(12) Patent Application Publication
(10) Pub. No.: US 2017/0328207 A1
(43) Pub. Date: Nov. 16, 2017

(54) COOLED COMPONENT WITH POROUS SKIN

(71) Applicant: General Electric Company, Schenectady, NY (US)

(72) Inventor: Ronald Scott Bunker, West Chester, OH (US)

(21) Appl. No.: 15/153,122

(22) Filed: May 12, 2016

(51) Int. Cl. F01D 5/18; F01D 5/14; F01D 5/28

(52) U.S. Cl. CPC F01D 5/183; F01D 5/288; F01D 5/147; F05D 2220/30; F05D 2300/5023; F05D 2300/514; F05D 2260/203

(57) ABSTRACT

A turbine component is configured to be cooled by structured porosity cooling. The component includes: a wall; a contiguous porous layer that is part of the wall; a first zone defined in the porous layer such that it has a first structured porosity, and a second zone defined in the layer such that it has a second structured porosity. The first structured porosity is different from the second structured porosity.

### BACKGROUND OF THE INVENTION

The present invention relates generally to gas turbine engines and more specifically to cooling components thereof.

Components in a gas turbine engine often include cooling holes for discharging air through very thin walls thereof. One example of such a component is an airfoil having a metering hole formed therethrough that is fluidly connected to a porous layer. The porous layer is configured to provide transpirational cooling. Conventionally, such porous layers are open-celled metallic layers that define flow paths that are randomly distributed and that are randomly shaped. Because conventional porous layers include randomly distributed and randomly shaped flow paths, they cannot be tailored to provide predetermined amounts of cooling at predetermined areas within a contiguous layer.

Accordingly, there remains a need for porous layers that can be tailored to provide flow paths of predetermined shape and/or predetermined distribution at predetermined areas of a contiguous layer.

### BRIEF DESCRIPTION OF THE INVENTION

This need is addressed by a gas turbine engine component that is configured for cooling and that includes a metering hole connected to a porous layer that has a structured porosity defined by a plurality of flow paths that have a predetermined shape and/or a predetermined distribution.

According to one aspect of the present invention, a turbine component is described that is configured to be cooled by structured porosity cooling, the component including: a wall; a contiguous porous layer that is part of the wall; a first zone defined in the porous layer such that it has a first structured porosity; a second zone defined in the layer such that it has a second structured porosity; and wherein the first structured porosity is different from the second structured porosity.

According to another aspect of the present invention there is described a turbine component that is configured to be cooled by structured porosity cooling, including: a substrate that has an exterior surface and an interior surface that bounds an interior space; a metering hole defined in the substrate such that the metering hole has one end that is open to the exterior surface of the substrate and another end that is open to the interior space; a porous layer positioned on the outer surface of the substrate; a first zone of structured porosity defined in the porous layer; a second zone of structured porosity defined in the porous layer; and wherein a degree of porosity of the first zone is different than a degree of porosity of the second zone and the interior space is fluidly connected to the exterior surface of the component via the metering hole, the porous layer, and the openings defined through the coating layer.

### BRIEF DESCRIPTION OF THE DRAWINGS

The invention may be best understood by reference to the following description taken in conjunction with the accompanying drawing figures in which:

FIG. 1 is a perspective view of a turbine blade wherein a wall of the turbine blade includes a porous layer for transpirational cooling of the wall;

FIG. 2 is a perspective view of a section of a wall of the turbine blade of FIG. 1 taken along line 2-2 in FIG. 1;

FIG. 3 is a cross-sectional view of the wall section of FIG. 2;

FIG. 4 is a cross-sectional view of an alternative wall section;

FIG. 5 is a cross-sectional view of another alternative wall section;

FIG. 6 is a cross-sectional view of the wall section of FIG. 2 during one step of manufacture;

FIG. 7 is a cross-sectional view of the wall section of FIG. 2 during another step of manufacture;

FIG. 8 is a cross-sectional view of the wall section of FIG. 2 showing plugs inserted in metering holes thereof;

FIG. 9 is a cross-sectional view of the wall section of FIG. 5, showing adhesive being applied to the wall section;

FIG. 10 is a cross-sectional view of the wall section of FIG. 6, showing powder being applied to the wall section; and

FIG. 11 is a cross-sectional view of the wall section of FIG. 7, showing powder being fused.

### DETAILED DESCRIPTION OF THE INVENTION

In general, a cooled component of the present disclosure includes a structured porous layer that has a structured porosity defined by predetermined zones formed therein, disposed on a substrate. Such predetermined zones having different structured porosity provide for different degrees of cooling on, and through, particular areas of the surface of the component as desired. A protective coating layer may be deposited on the uppermost surface of the porous layer.

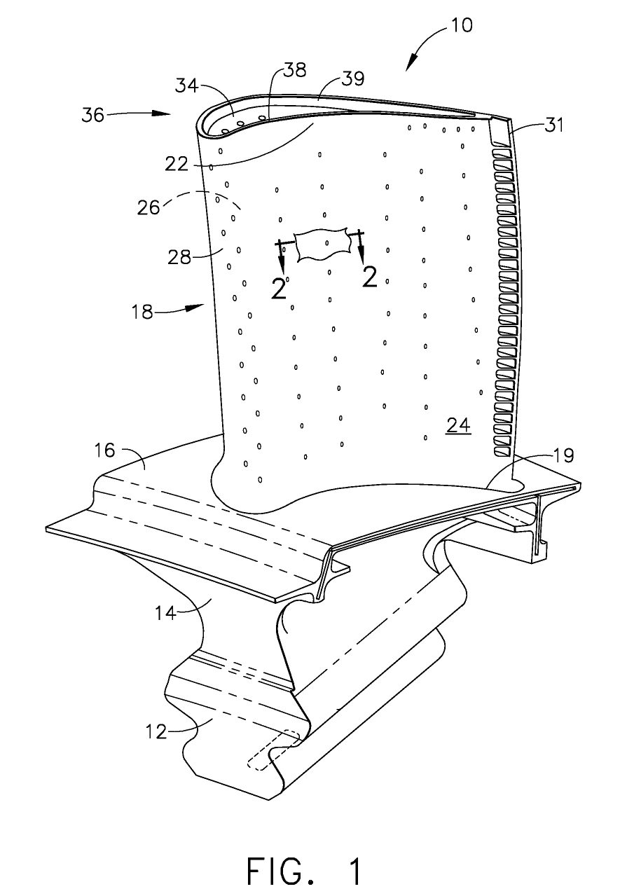

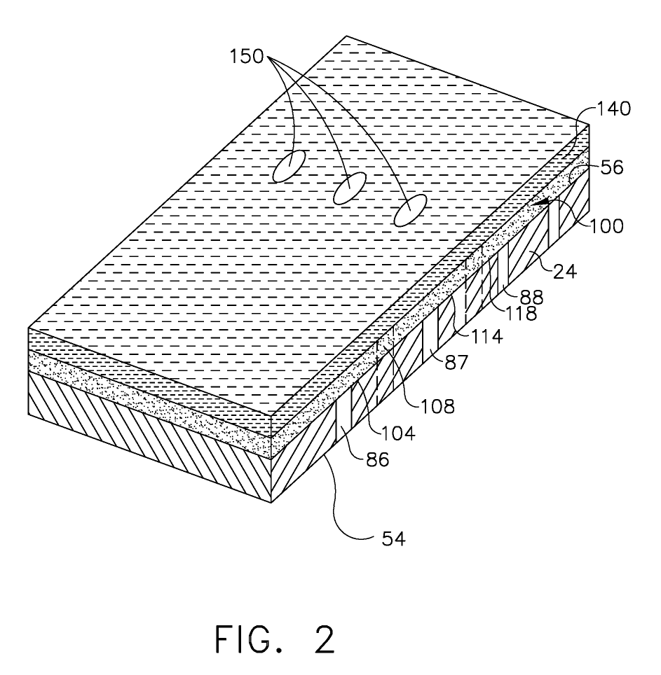

Now, referring to the drawings wherein identical reference numerals denote the same elements throughout the various views, FIGS. 1 and 2 illustrate an exemplary turbine blade 10 having a porous layer 100 configured to provide differentiated cooling via structured porosity. The porous layer 100 has a plurality of zones each with different predetermined structured porosities in one contiguous layer. The turbine blade 10 is merely one example of a cooled component that may incorporate a wall structure with a porous layer as described herein.

As used herein, the term “structured porosity” refers to a plurality of wall portions and void areas that are positioned in a planned and predetermined configuration. Such positioning can be accomplished, for example, by a layered manufacturing approach such as the additive manufacturing method described below. The position of each wall portion and each void area is defined according to a coordinate system such as an XYZ system within a predetermined layer. After multiple layers are produced in this manner, a porous layer having a structured porosity is produced. It should be appreciated that at least some voids within the porous layer are fluidly connected to each other so as to provide a predetermined flow path such as an angled or directed flow. Alternatively, substantially random flow directionality can also be provided as a controlled set of designed effective flow areas. As used here the term “structured porosity” stands in contrast to porous structures constructed using prior art methods for generating porous structures, such as thermal or chemical deposition methods, which can result in random, unpredictable and/or inconsistent structures.

The turbine blade 10 includes a conventional dovetail 12, which may have any suitable form including tangs that engage complementary tangs of a dovetail slot in a rotor disk (not shown) for radially retaining the blade 10 to the disk as it rotates during operation. Alternatively, the turbine blade 10 can be an integral part of an integrally-bladed rotor or “blisk”. A blade shank 14 extends radially upwardly from the dovetail 12 and terminates in a platform 16 that projects laterally outwardly from, and surrounds, the shank 14. A hollow airfoil 18 extends radially outwardly from the platform 16 and into the hot gas stream. The airfoil has a root 19 at the junction of the platform 16 and the airfoil 18, and a tip 22 at its radially outer end. The airfoil 18 has a concave pressure side wall 24 and a convex suction side wall 26 joined together at a leading edge 28 and at a trailing edge 31.

The airfoil 18 may take any configuration suitable for extracting energy from the hot gas stream and causing rotation of the rotor disk. The tip 22 of the airfoil 18 is closed off by a tip cap 34 which may be integral to the airfoil 18 or separately formed and attached to the airfoil 18. An upstanding squealer tip 36 extends radially outwardly from the tip cap 34 and is disposed in close proximity to a stationary shroud (not shown) in the assembled engine, in order to minimize airflow losses past the tip 22. The squealer tip 36 comprises a pressure side tip wall 38 disposed in a spaced-apart relationship to a suction side tip wall 39. The tip walls 38 and 39 are integral to the airfoil 18 and form extensions of the pressure and suction side walls 24 and 26, respectively. The outer surfaces of the pressure and suction side tip walls 38 and 39 respectively form continuous surfaces with the outer surfaces of the pressure and suction side walls 24 and 26.

The airfoil 18 may be made from a material such as a nickel- or cobalt-based alloy having good high-temperature creep resistance, known conventionally as “superalloys.” Other nonlimiting examples of suitable materials include refractory metals such as titanium; ceramics; ceramic matrix composites; composites of metal and ceramic; and combinations thereof.

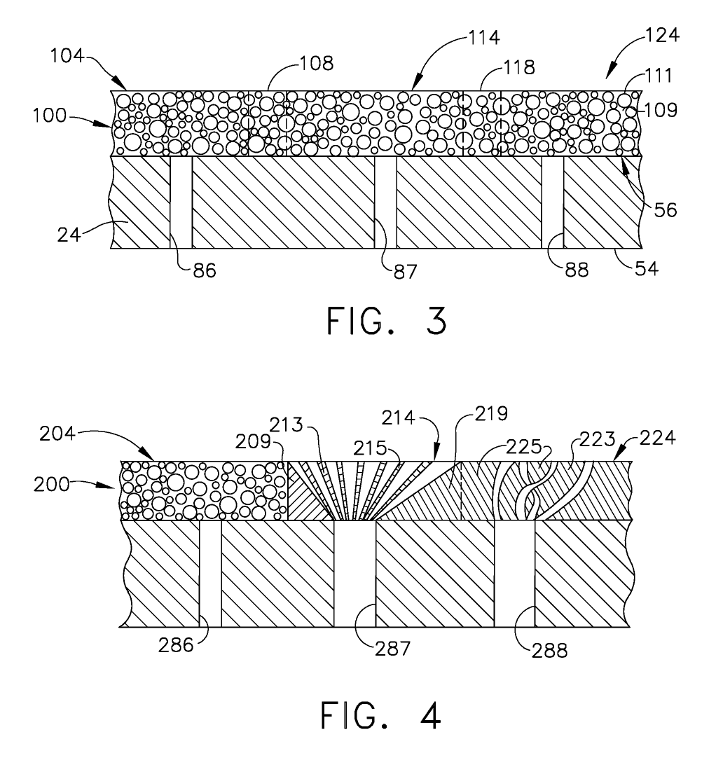

Referring now to FIGS. 2 and 3, one or more metering holes pass through the pressure side wall 24. First, second, and third metering holes 86, 87, and 88 are shown in this example, extending from an interior surface 54 to an exterior surface 56. The porous layer 100 overlies the exterior surface 56 and thus the pressure side wall 24 may be considered “a substrate” for the porous layer 100. The metering holes 86, 87, and 88 communicate with an interior of the airfoil 18 (not shown) and with the porous layer 100 as will be described further below. It will be understood that the metering holes 86, 87, and 88 can be positioned at various angles, and can have varying sizes, cross-sectional shapes, inlet shapes, and outlet shapes.

In the example shown in FIG. 2 an optional protective coating 140 such as an environmental coating or a thermal barrier coating overlies the porous layer 100. The protective coating 140 may itself be porous and may incorporate exit holes 150. The porous layer 100 defines flow paths that are fluidly connected to one or more of the metering holes 86, 87, and 88 and to the protective coating 140.

The porous layer 100 includes two or more zones. In the illustrated example, the porous layer 100 is defined to have a first zone 104, a second zone 114, and a third zone 124. As noted above, the porosity of each zone 104, 114, 124 is structured, that is, it comprises wall portions 109 (i.e., portions of solid material) adjacent to void areas 111, where the shape, size, and location in 3-D space of each wall portion 109 and each void area 111 is built according to a predetermined pattern.

The void areas 111, representing open space available through which a fluid can pass, can be configured in various ways. Nonlimiting examples of void shapes include: a structure analogous to an open celled foam, a plurality of tubes, a plurality of passageways, interconnected voids, and a combination thereof.

Each of the zones 104, 114, 124 has a structured porosity configured differently from the other zones. This may also be described as having “different structured porosity”.

In this particular example, each of these zones has a different degree of porosity. As used herein, the term “degree of porosity” refers to an amount of open space available in that zone through which a fluid can pass. Stated another way, the open area through which gases can transfer from the metering holes 86, 87, 88 through the porous layer 100 is different in each of the first zone 104, the second zone 114, and the third zone 124.

A first boundary zone 108 is positioned between the first zone 104 and the second zone 114. A second boundary zone 118 is positioned between the second zone 114 and the third zone 124. According to the illustrated embodiment, the structured porosity within the first zone 104 is generally constant throughout. The structured porosity within the second boundary zone 108 gradually transitions from that of the first zone 104 to the porosity of the second zone 114. In this regard, the porous layer 100 has multiple degrees of porosity defined therein with predetermined transitions. In this manner, different degrees of cooling can be provided to different areas of the airfoil 10 in predetermined amounts. Further, the porous layer 100 can have multiple zone angles, i.e. the angle and direction at which the gas flows relative to the blade surface, multiple orientations of passageways therein, multiple sizes, and passageways of various shapes.

It should be appreciated that in some embodiments the transition between adjacent zones of porosity will be abrupt. In other embodiments, zones are separated by solid material that is produced in the same additive manufacturing step as the zones of porosity.

In the illustrated example, the adjacent zones 104, 114, and 124 are fluidly connected to each other such that each of the metering holes 86, 87, 88 is fluidly connected to the zone it feeds directly and to the other zones shown in FIG. 3 via the adjacent zones. The interior space bounded by the interior surface 54 is fluidly connected to the porous layer 100 via the metering holes 86, 87, and 88.

FIG. 4 illustrates an example of an alternative porous layer 200. The porous layer 200 includes a first zone 204, a second zone 214, and a third zone 224, and associated metering holes 286, 287, and 288, respectively. The first zone 204 is configured with a structured porosity such that pathways analogous to those found in an open celled foam are defined. The second zone 214 is configured with a fanned array of diffuser-shaped channels 213, defined by walls 215. The third zone 224 is configured with a plurality of curved channels 223, defined by walls 225. The zones are not fluidly connected to each other through the porous layer 200. In this regard, the porous areas of first zone 204 are separated from the porous areas of the second zone 214 by solid areas 209. Likewise, the porous areas of the second zone 214 are separated from the porous areas of the third zone 224 by solid areas 219. In FIG. 4 it can be seen that different combinations of metering holes and zones of porosity can be configured in a single porous layer 200.

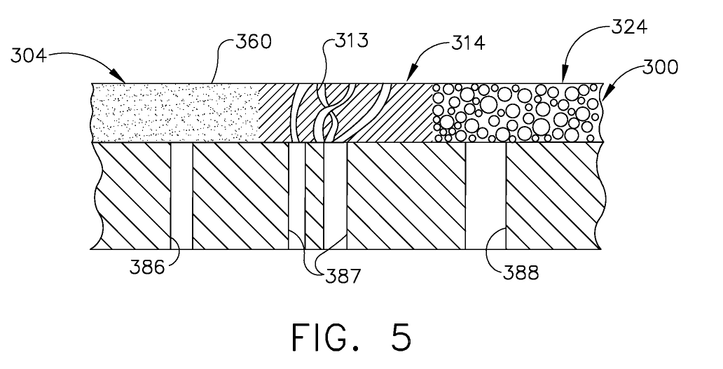

In another example as shown in FIG. 5, a porous layer 300 includes three zones of porosity. In a first zone 304, the porous layer 300 is defined in a structured manner to have a structured porosity. Porous layer 300 has pathways that are analogous to those found in an open celled foam. The pathways in porous layer 300 are not random and are defined in a predetermined pattern from a metering hole 386 to an outer surface 360. In a second zone 314, serpentine tubes 313 are defined within the porous layer 300 such that at least some of the tubes fluidly connect metering holes 387 to the outer surface 360. In a third zone 324 a structured porosity is also defined such that pathways analogous to those found in an open celled foam are defined in a predetermined pattern from a metering hole 388 to the outer surface 360. In the illustrated example the percent of voids or degree of porosity present in the third zone 324 is different than that in the first zone 304. Alternatively, the porosity of the third zone 324 can be the same as that in the first zone 304.

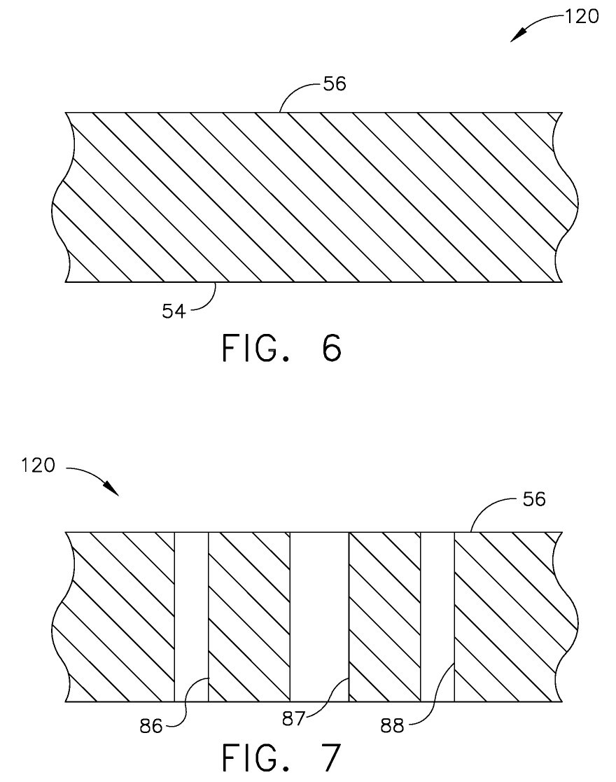

An example of one possible method of manufacturing the porous layer 100 will now be described with reference to a portion or section 120 of the pressure side wall 24 as shown in FIG. 6. The wall section 120 is generally representative of the wall section of any turbine component, of any shape such as flat, convex, concave, and/or complexly curved, It should be understood that the providing step of the wall section 120 includes but is not limited to manufacturing of the wall section 120 or obtaining a pre-manufactured wall section 120. Methods of manufacturing the wall section 120 include but are not limited to those conventionally known such as casting, machining, and a combination thereof.

The metering holes 86, 87, and 88 (FIG. 7) are formed through the wall section 120 and extend from interior surface 54 to exterior surface 56. For example, they may be defined by cores or rods during a casting process, or by using a conventional method such as drilling subsequent to casting. The wall section 120 is substantially impervious, and may be completely solid, except for the metering holes 86, 87, and 88. As used herein, the term “substantially” refers to the limits of achievable manufacturing tolerances. In other words a wall section which is intended to be solid but has some porosity attributable to manufacturing variation may be said to be substantially impervious.

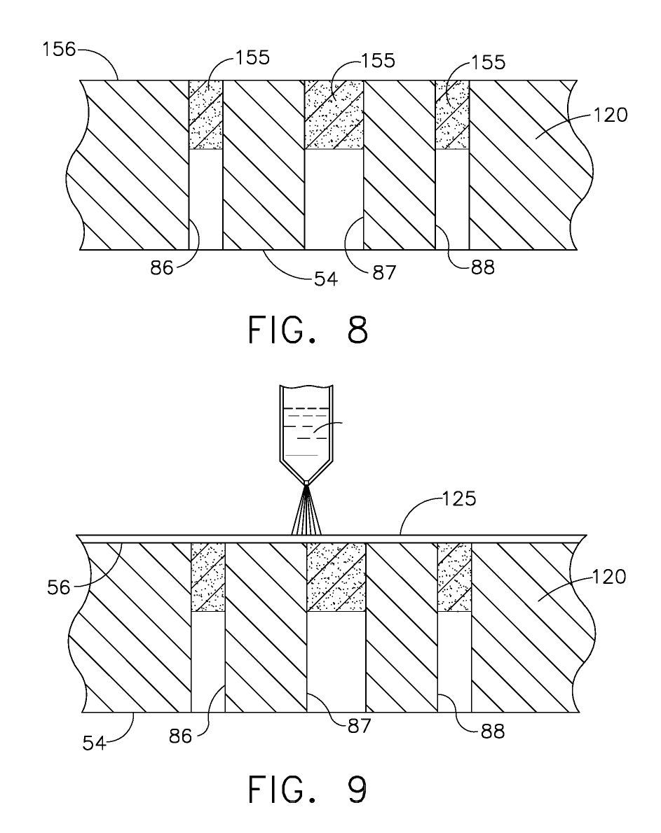

The steps of forming a structured porous layer on the wall section 120 can be understood by the following description with reference to FIGS. 8-11. Referring to FIG. 8, the metering holes 86, 87, 88 are plugged by removable plugs 155.

Next, a powder is adhered to the exterior surface 56. As used herein, the term “adhere” refers to any method that causes a layer to adhere to the surface with sufficient bond strength so as to remain in place during a subsequent powder fusion process. “Adhering” implies that the powder has a bond or connection beyond simply resting in place under its own weight, as would be the case with a conventional powder-bed machine. For example, the surface may be coated with an adhesive product, which may be applied by methods such as dipping or spraying. One non-limiting example of a suitable low-cost adhesive is Repositionable 75 Spray Adhesive available from 3M Company, St. Paul, Minn. 55144 US. Alternatively, powder could be adhered by other methods such as electrostatic attraction to the part surface, or by magnetizing the powder (if the part is ferrous). FIG. 9 illustrates an adhesive 125 being applied to the exterior surface 56.

As shown in FIG. 10, a layer of powder P for example, metallic, ceramic, and/or organic powder is deposited over the adhesive 125. As a non-limiting example, the thickness of the powder layer may be about 10 micrometers (0.0004 in.). As used herein, the term “layer” refers to an incremental addition of mass and does not require that the layer be planar, or cover a specific area or have a specific thickness.

The powder P may be applied by dropping or spraying the powder P, or by dipping the wall section 120 in powder. Powder application may optionally be followed by brushing, scraping, blowing, or shaking as required to remove excess powder, for example to obtain a uniform layer. It is noted that the powder application process does not require a conventional powder bed or planar work surface, and the wall section 120 may be supported by any desired means, such as a simple worktable, clamp, or fixture.

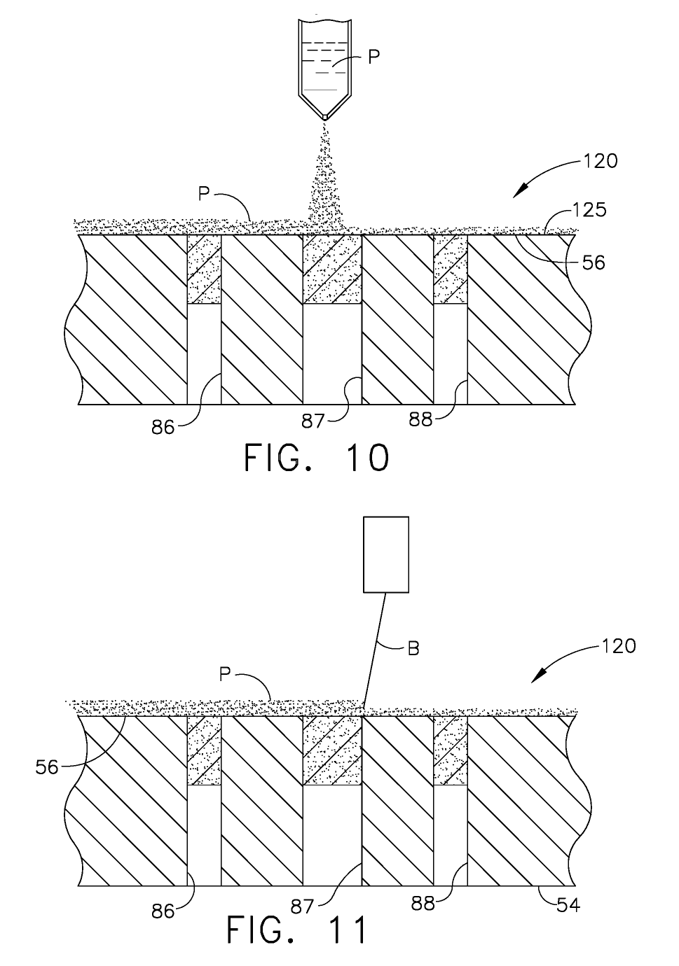

As can be seen in FIG. 11, once the powder P is deposited, a directed energy source 150 (such as a laser or electron beam) is used to melt a layer of the porous layer being built. The directed energy source emits a beam “B” and a beam steering apparatus is used to steer the beam B over the exposed powder surface in an appropriate pattern. The exposed layer of the powder P is heated by the beam to a temperature allowing it to melt, flow, and consolidate and fuse to or adhere to a substrate with which it is in contact. In this manner, the particles that made up powder P now exist as part of the wall section 120. This step may be referred to as fusing the powder. Unfused powder can be removed at this stage prior to the next cycle of applying an adhesive, applying powder, and fusing the powder. However, in the illustrated embodiment, unfused powder that is not removed in each step remains in place. In this regard the unfused powder can operate to support powder of the next layer.

This cycle of depositing powder and then directed energy melting the powder is repeated until the porous layer 100 (FIG. 3) is complete.

The process described above is merely one example of an additive manufacturing process. The term “Additive manufacturing” describes a process which involves layer-by-layer construction or additive fabrication (as opposed to material removal as with conventional machining processes). Such processes may also be referred to as “rapid manufacturing processes”. Additive manufacturing processes include, but are not limited to: Direct Metal Laser Melting (DMLM), Laser Net Shape Manufacturing (LNSM), electron beam sintering, Selective Laser Sintering (SLS), 3D printing, such as by inkjets and laserjets, Sterolithography (SLA), Electron Beam Melting (EBM), Laser Engineered Net Shaping (LENS), and Direct Metal Deposition (DMD).

Any of these additive manufacturing processes could be used to form the porous layers described herein. For example, if the entire turbine blade 10 were to be built by additive manufacturing, then it could be done using a powder bed additive manufacturing approach for both the substrate (i.e. the airfoil walls) and the structured porous layers, in the same build process.

The process and structure described herein has several advantages over the prior art. The porous structure is engineered and tailored to predetermined dimensions positioned on a preformed structure such as the base wall of an airfoil that may have an outer layer or outer coating positioned thereon. The porous structure can have different zones with different levels of structured porosity in a single contiguous layer. The contiguous layer can be constructed by additive manufacturing as described above. Gradual transitions in the degree of porosity can be achieved in the porous layer that cannot be achieved according to prior art methods.

The foregoing has described a porous structure and a method for its manufacture. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying potential points of novelty, abstract and drawings), or to any novel one, or any novel combination, of the steps of any method or process so disclosed.

What is claimed is:

1. A turbine component that is configured to be cooled by structured porosity cooling, the component comprising:
a wall;
a contiguous porous layer that is part of the wall;
a first zone defined in the porous layer such that it has a first structured porosity;
a second zone defined in the layer such that it has a second structured porosity; and
wherein the first structured porosity is different from the second structured porosity.

2. The component according to claim 1, wherein the wall includes a substantially impervious layer that has at least one metering hole defined therein.

3. The component according to claim 2, wherein the at least one metering hole is defined through the substantially impervious layer such that an interior surface of the wall is fluidly connected to the porous layer.

4. The component according to claim 3, wherein the interior surface of the wall is fluidly connected to the first zone and to the second zone.

5. The component according to claim 4, wherein the first zone is fluidly connected to the second zone via the porous layer.

6. The component according to claim 4, wherein the interior surface of the wall is fluidly connected to the first zone and to the second zone via one metering hole.

7. The component according to claim 4, wherein the interior surface of the wall is fluidly connected to the first zone via a first metering hole and to the second zone via a second metering hole.

8. The component according to claim 7, wherein the first zone is fluidly connected to the second zone via the first metering hole and the second metering hole.

9. The component according to claim 8, wherein the first zone is fluidly connected to the second zone via the porous layer.

10. The component according to claim 2, wherein the porous layer is positioned between a protective layer and the substantially impervious layer and the interior surface of the wall is fluidly connected to an exterior surface of the protective layer.

11. The component according to claim 10, wherein the protective layer is substantially impervious and openings are defined through the protective layer such that the porous layer is fluidly connected to an exterior surface of the protective layer.

12. The component according to claim 1, wherein the wall is a part of an airfoil.

13. A turbine component that is configured to be cooled by structured porosity cooling, comprising:
a substrate that has an exterior surface and an interior surface that defines an interior space;
a metering hole defined in the substrate such that the metering hole has one end that is open to the exterior surface of the substrate and another end that is open to the interior space;
a porous layer positioned on the outer surface of the substrate;
a first zone of structured porosity defined in the porous layer;
a second zone of structured porosity defined in the porous layer; and
wherein a degree of porosity of the first zone is different than a degree of porosity of the second zone and the interior space is fluidly connected to the exterior surface of the component via the metering hole, the porous layer, and the openings defined through the coating layer.

14. The component according to claim 13, comprising:
a second metering hole, and
wherein the second metering hole has one end that is adjacent the second zone of porosity and the first metering hole has one end that is adjacent the first zone of porosity.

15. The component according to claim 13, wherein the first zone porosity and the second zone of porosity have a cellular configuration.

16. The component according to claim 15, wherein the first zone of porosity and the second zone of porosity each have substantially uniform degrees of porosity throughout.

17. The component according to claim 16, wherein a third zone of porosity is positioned between the first zone of porosity and the second zone porosity.

18. The component according to claim 17, wherein the third zone of porosity has a degree of porosity substantially equal to that of the first zone of porosity in an area near the first zone of porosity and a degree of porosity substantially equal to that of the second zone of porosity in an area near the second zone of porosity.

19. The component according to claim 18, wherein the degree of porosity of the third zone of porosity transitions gradually from near the first zone of porosity to near the second zone porosity.

20. The component according to claim 17, wherein the third zone of porosity is impervious.

21. The component according to claim 20, wherein the porous layer is one contiguous unit.

22. The component of claim 13 further comprising a coating layer overlying the porous layer, the coating layer including openings therethrough disposed in fluid communication with the porous layer.
